(19) United States
(12) Patent Application Publication
(10) Pub. No.: US 2008/0047209 A1
(43) Pub. Date: Feb. 28, 2008

(54) Refrigerator Unit and/or Freezer Unit

(76) Inventors: Daniel Hinterholzer, Lienz (AT); Martin Muhlburger, Osterreich (AT); Wolfgang Walder, Osterreich (AT)

Correspondence Address: DILWORTH & BARRESE, LLP, 333 EARLE OVINGTON BLVD., SUITE 702, UNIONDALE, NY, 11553, US

(21) Appl. No.: 11/791,682

(22) PCT Filed: Nov. 29, 2005
(86) PCT No.: PCT/EP05/12745

§ 371 Date: May 24, 2007

(30) Foreign Application Priority Data
Nov. 29, 2004 (DE) 20 2004 018 464.8
Dec. 23, 2004 (DE) 20 2004 019 865.7

(51) Int. Cl. F25D 23/02; B23P 17/00; E06B 3/67

(52) U.S. Cl. 52/208; 220/592.02; 29/462

(57) ABSTRACT

The present invention relates to a refrigerator unit and/or a freezer unit comprising a glass door which has a metal frame into which a glazing pane has been inserted. In accordance with the invention, the refrigerator unit and/or a freezer unit is characterized in that the metal frame comprises a metal jacket made peripherally integrally in one piece.

The present invention relates to a refrigerator unit and/or a freezer unit comprising a glass door which has a metal frame into which a glazing pane has been inserted. Refrigeration units in the sense of the present application can also be coolers in particular for the storage of wine.

Previous glass doors of refrigerator units are disadvantageous in a number of respects. To the extent their metal frame comprises extruded aluminum sections which are miter cut and assembled, gaps are unavoidable at the connection points due to tolerances. Additional applications such as locks, viewing windows and the like can only be introduced into the extruded sections with difficulty, In addition, the contour of the metal frame is more or less predetermined by the frame sections and at best slightly adaptable by additional machining.

To the extent the frame of glass doors is made up of extruded plastic sections and/or injection molded parts by welding or plugging together, as a rule no high-quality visual appearance can be achieved. Visible abutment points arise due to the welding. In addition, no uniform color or finish can usually be achieved due to the combination of different plastic parts.

It is therefore the underlying object of the present invention to provide an improved refrigerator unit and/or a,freezer unit of the named kind which avoids disadvantages of the prior art and further develops it in an advantageous manner. A visually high-quality glass door with sufficient stability should in particular be provided.

This object is solved in accordance with the invention by a refrigerator unit and/or a freezer unit in accordance with claim 1. Preferred aspects of the invention form the subject of the dependent claims.

In accordance with the invention, the metal frame surrounding the glazing pane is therefore not assembled from a plurality of pieces. It comprises a metal jacket which is made peripherally integrally in one piece and is free of seams at least on the visible side of the door. A previously unachieved, homogeneous visual appearance is thereby realized. Color deviations, visible gap formation or abutment points are eliminated. The outer envelope of the door comprises a uniformly made and oriented material over a full area. To nevertheless achieve the required stability, a frame reinforcement is advantageously inserted peripherally into the metal jacket. The shape of the metal jacket of integrally one piece can hereby be designed with substantially more variants and in almost any desired manner irrespective of the customary stability demands on the metal frame.

The metal jacket of integrally one piece in particular comprises a sheet metal section which is formed without chips, which is produced from a one-piece sheet metal plate and which can have a central stamped-out portion for the glazing pane. The metal jacket is preferably deep-drawn. Alternatively or additionally, it can be bent and flanged. Non-bent or non-flanged marginal webs can be welded at abutment points in the non-visible region.

The frame reinforcement can generally have different designs.

In accordance with an advantageous embodiment of the invention, the frame reinforcement can have a plurality of sectional pieces which are connected to the metal jacket at the rear side thereof. In particular extruded plastic sections or extruded aluminum sections can be used which are placed onto the rear side of the metal jacket and are advantageously adhesively bonded thereto.

To increase the stiffness achieved by the sectional pieces even further, the sectional pieces are advantageously connected to one another, in particular adhesively bonded to one another and/or jammed together so that they form a rigid peripheral reinforcement frame. They can also be latched to one another. Shear stresses can in particular also be intercepted particularly easily thereby.

Alternatively or additionally, a foam body, with which the metal jacket can be foamed at the rear side or filled up with foam, can also be provided as the frame reinforcement The inner side of the metal jacket is connected to the foam body in an areal manner, preferably fully areally. In particular when the metal jacket has flanks inclined toward one another in cross-section, a considerable stiffening can be achieved by the foaming at the rear side. At the same time, the foaming at the rear side of the metal jacket substantially improves the heat transfer coefficient, the so-called “K-value” of the section. Furthermore, a considerable reduction in condensate formation at the frame and at the transition to the glazing pane is achieved by the foam body. The metal frame can also be kept largely free of condensate without a heating.

The glazing pane can be attached to the metal frame in different manners. In a further development of the invention, a glazing pane holder is provided for the glazing pane and can be fastened to the frame reinforcement. If the previously described foam filler is provided as the frame reinforcement, the glazing pane holder can be foamed into the foam body. If the previously named sectional pieces are provided as the frame reinforcement, the glazing pane holder can be formed by these sectional pieces themselves or can be integrally shaped onto them in the manner of a flange.

The glazing pane holder advantageously has support limbs which project inwardly from the metal frame and on which the flat side of the glazing pane lies. A suitable connection is expediently provided between the support limb and the glazing pane. The glazing pane can in particular be adhesively bonded onto the support limb. The door obtains its final stiffness thanks to the adhesive bonding of the glass to these parts.

To achieve good heat insulation, the glazing pane is a multi-glazing in a further development of the invention in which a plurality of glass panes are arranged spaced apart from one another. In accordance with an embodiment of the invention, three glass panes can be provided which are connected to one another by peripheral spacers at the rim side.

In a further development of the invention, a seal, in particular an elastic lip seal, is provided between the metal jacket and the glazing pane and/or between the glazing pane holder and the glazing pane. This prevents moisture from entering, on the one hand. On the other hand, a clean termination is provided.

To illuminate the door, a lighting device which directs light into the glazing pane can be provided at the metal frame. For this purpose light-emitting diodes or fluorescent tubes can be provided in the transition region between the metal frame and the glazing pane. Optionally, a separate illumination of the unit interior can hereby be dispensed with. Further additional applications such as a frame heating can be provided inside the metal jacket.

If the door should be extended toward the unit carcass above and/or below its seal in order, for example, to cover the unit or to project over it, additional parts, in particular door extensions, can be attached to the metal frame and can then optionally also accept additional components such as a lock or thermometer.

The invention will be explained in more detail in the following with reference to preferred embodiments and to associated drawings. There are shown in the drawings:

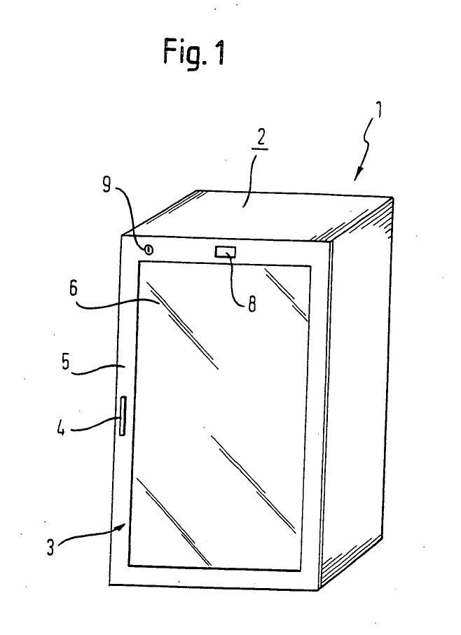

FIG. 1: a perspective view of a refrigerator unit with a glass door in accordance with a preferred embodiment of the invention in a schematic representation;

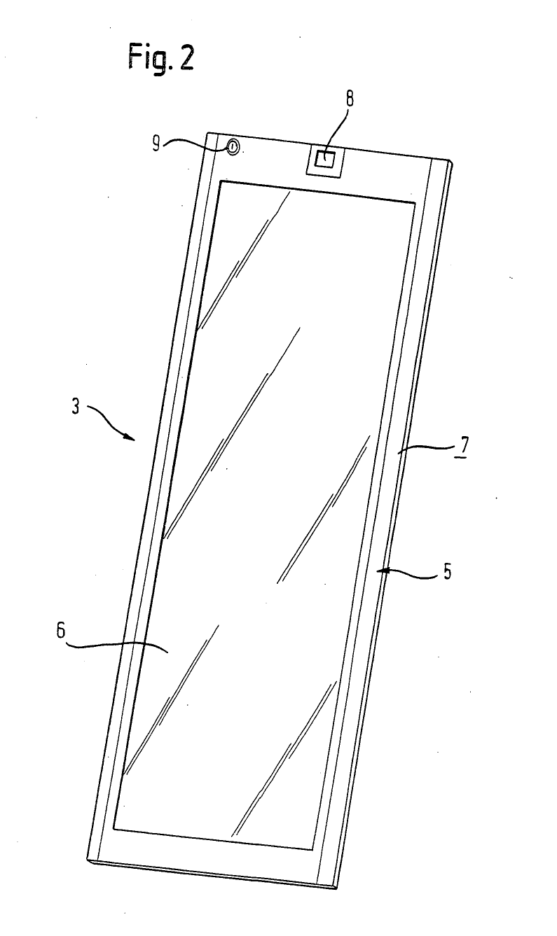

FIG. 2: a perspective individual view of the glass door of the refrigerator unit from FIG. 1;

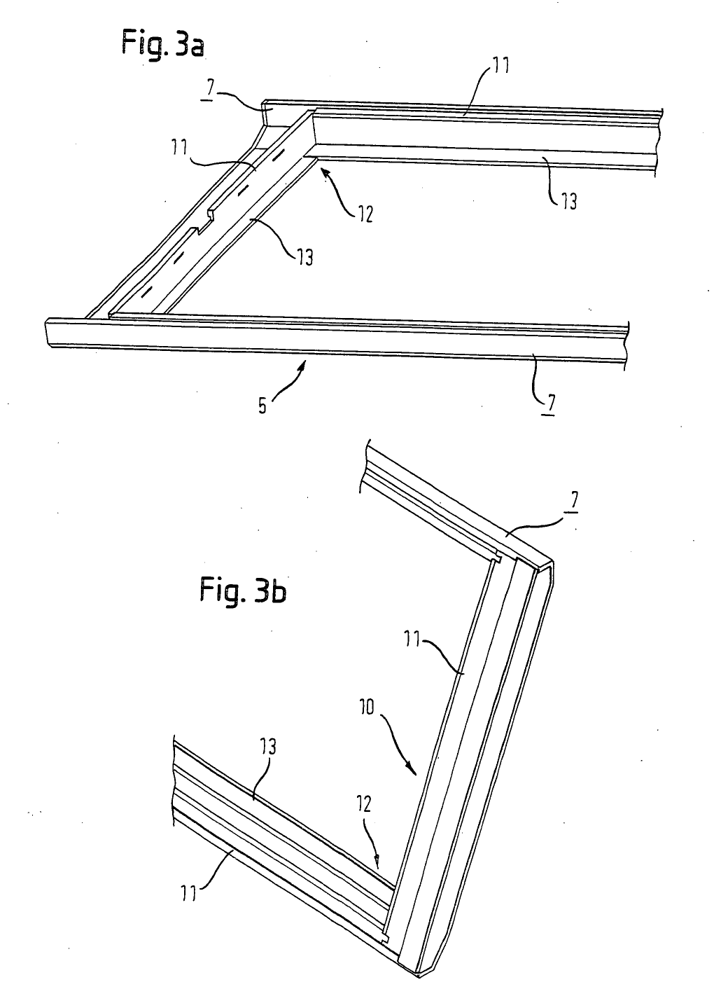

FIG. 3: a perspective inner view of the metal frame of the glass door from FIG. 2 in a perspective representation which shows the frame reinforcement inserted into the metal jacket of the metal frame and the glazing pane holder shaped thereon;

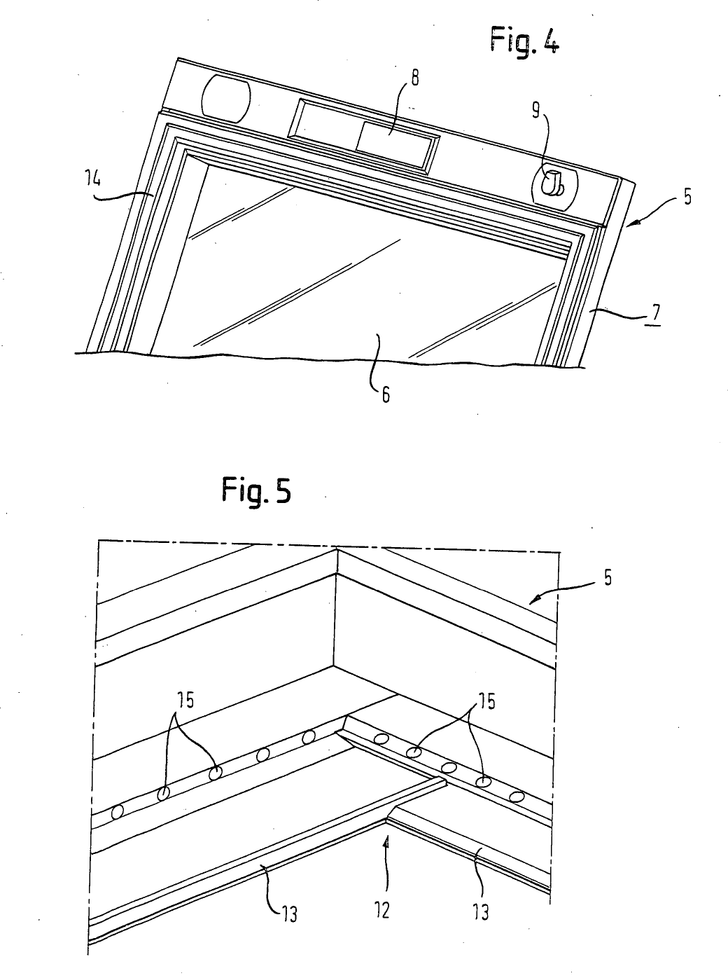

FIG. 4: a perspective part view of the rear side of the glass door from the preceding Figures which is shown with an inserted glazing pane and with a door seal; and

FIG. 5: an enlarged perspective representation of the glazing pane holder inserted into the metal jacket of the glass door which shows a lighting device arranged at the narrow sides of the glazing pane.

The refrigerator unit 1 shown in FIG. 1 has a substantially cubic unit carcass 2 which is itself made open at the front side and can be closed by a door 3. The door 3 is supported in a manner known per se pivotable at the unit carcass 2 around a vertical door pivot axis so that it can be pivoted open and closed around the pivot axis disposed at the right in FIG. 1 with the aid of a door handle 4.

As FIG. 2 shows in more detail, the door 3 is made as a glass door which has a metal frame 5 into which a glazing pane 6 is inserted. With such glass doors, the metal frame is made very narrow as a rule. The glazing pane 6 as a rule takes up more than ⅔ of the width or of the height of the door.

The metal frame 5 comprises a metal jacket 7 which is made peripherally integrally in one piece, and which is in particular made from a one-piece sheet metal plate, in a chip-free forming process. The metal jacket 7 can in particular be deep-drawn or bent and flanged. The metal jacket 7 hereby advantageously has no seam points or abutment points, at least on its visible front side which FIG. 2 shows, as is the case with conventional metal glass doors which are assembled from a plurality of metal frame pieces.

Stamped-out portions for a thermometer 8 and a lock 9 are introduced into the metal jacket 7 in the region of the upper transverse piece of the metal frame 5.

To give the door the required stability and stiffness, a frame reinforcement 10 is inserted into the metal jacket 7 at the rear side in the form of sectional pieces 11 which are connected to one another by adhesive bonding to obtain a closed reinforcement frame which stabilizes the door, but can also optionally be latched or jammed together with one another. The reinforcing sectional pieces 11 can be extruded sections such as are inserted along the lateral limbs of the metal frame 5 in the drawn embodiment (cf. FIG. 3a) or they can be injected molded parts such as are inserted along the transverse limbs of the metal frame 5 in the drawn embodiment (cf. FIG. 3b).

The glazing pane 6 is held in the central stamped-out portion of the metal jacket 7 by means of a glazing pane holder 12 which encompasses support limbs 13 projecting inwardly substantially parallel to the plane of the glazing pane. As FIGS. 3a and 3b show, the support limbs 13 are shaped at the extrusion sections serving laterally as reinforcing section pieces 11. In accordance with FIG. 3, separate support limbs 13 are provided at the end faces. It is understood that they can be shaped in an advantageous manner to the sectional pieces 11 inserted there to save an additional part. The support limbs 13 define a marginal web of the central stamped-out portion in the metal jacket 7, said marginal web running all around, so that the glazing pane can be inserted into the stamped-out portion from the rear side and can be placed onto the support limbs 13. It is preferably adhesively bonded there.

With a flanged embodiment of the metal jacket 7, covers 14 can be placed onto the frame reinforcement 10 at the end face in order to cover the sheet metal edges and the support and to improve the visual impression as FIG. 4 shows.

To seal the door 3 with respect to the unit carcass 2, a seal 14 is seated running around the glazing pane 6 on the metal frame 5 at the rear side and is pressed toward the unit carcass 2 on the closing of the door.

If the door 3 should be extended above and/or below the seal 14 in order to cover or project over the unit, for example, additional parts can be installed which can then optionally receive the additional components such as the lock 9 or the thermometer 8.

As FIG. 5 shows, a lighting unit 15 is furthermore provided in the metal frame 5 which, in the drawn embodiment, comprises a row of light-emitting diodes, but can also be made as neon tubes or a plurality of neon tubes. The lighting device 15 is seated on the rear side of the metal jacket 2 outwardly adjacent to the support limbs 13 of the glazing pane holder 12 so that the lighting device 15 comes to lie approximately adjacent to the narrow side of the inserted glazing pane 6 and the light is directed into the glazed pane. Lighting inside the unit carcass 2 can hereby optionally be dispensed with. A frame heating can be installed additionally or alternatively to the lighting unit thanks to the flexibility in the sectional pieces 11 of the frame reinforcement 10 in order to prevent dew formation on the glass.

A homogeneous and quality visual impression is achieved by the throughgoing metal jacket 7 at the visible surface which now comprises a material dyed the same and oriented over the full area. Color deviations, visible gap formation or abutment positions are hereby precluded. In addition, the option exists of printing, lacquering or thermal sublimation, whereby the visible surface of the metal frame can be adapted to customized desires. A color matching of the glass door to the unit carcass 2 is naturally also possible, which was previously only possible with restrictions due to different materials.

1. A refrigerator unit and/or a freezer unit comprising a glass door (3) having a metal frame (5) into which a glazing pane (6) is inserted, wherein the metal frame (5) comprises a metal jacket (7) made peripherally integrally in one piece.

2. A refrigerator unit and/or a freezer unit in accordance with claim 1, wherein a frame reinforcement (10) is inserted peripherally into the metal jacket (7).

3. A refrigerator unit and/or a freezer unit in accordance with claim 2, wherein the frame reinforcement (10) has a plurality of sectional pieces (11), in particular extruded sections, which are connected to the metal jacket (7) at the rear side thereof.

4. A refrigerator unit and/or a freezer unit in accordance with claim 1, wherein the sectional pieces (11) are connected to one another, in particular adhesively bonded to one another, and are assembled to form a rigid peripheral reinforcement frame.

5. A refrigerator unit and/or a freezer unit in accordance with claim 2, wherein the frame reinforcement (10) includes a foam body with which the metal jacket (7) is foamed at the rear side or filled up with foam.

6. A refrigerator unit and/or a freezer unit in accordance with claim 1, wherein the metal jacket (7) comprises a sheet metal section formed chip-free, in particular deep-drawn and/or bent and flanged.

7. A refrigerator unit and/or a freezer unit in accordance with claim 2, wherein a glazing pane holder (12), to which the glazing pane (6) is fastened, is fastened to the frame reinforcement (10).

8. A refrigerator unit and/or a freezer unit in accordance with claim 7, wherein the frame reinforcement (10) includes a foam body with which the metal jacket (7) is foamed at the rear side or filled up with foam, and the glazing pane holder (12) is foamed into the foam body (19).

9. A refrigerator unit and/or a freezer unit in accordance with claim 7, wherein the frame reinforcement (10) has a plurality of sectional pieces (11), in particular extruded sections, which are connected to the metal jacket (7) at the rear side thereof, and the glazing pane holder (12) is fastened to the sectional pieces (11) in the manner of a flange, is in particular shaped to it integrally in one piece.

10. A refrigerator unit and/or a freezer unit in accordance with claim 1, wherein the glazing pane holder (12) has a support limb (13) which projects inwardly from the metal frame (5) and on which the flat side of the glazing pane (6) lies, is preferably firmly adhered.

11. A refrigerator unit and/or a freezer unit in accordance with claim 1, wherein the glazing pane (6) is a multi-glazing in which a plurality of glass panes are arranged spaced apart from one another, are preferably connected to one another by spacers.

12. A refrigerator unit and/or a freezer unit in accordance with claim 1, wherein a seal, in particular an elastic lip seal, is provided between the metal jacket (7) and the glazing pane (6) and/or between the glazing pane holder (12) and the glazing pane (6).

13. A refrigerator unit and/or a freezer unit in accordance with claim 1, wherein an additional application, in particular a heating (15), a thermometer (8) or the like, is provided at the metal frame (5) between the metal jacket (7) and the glazing pane (6).

14. A refrigerator unit and/or a freezer unit in accordance with claim 1, wherein a lighting device (15) to illuminate the glazing pane (6) is provided at the metal frame (5).

15. A refrigerator unit and/or a freezer unit in accordance with claim 2, wherein the metal jacket (7) comprises a sheet metal section formed chip-free, in particular deep-drawn and/or bent and flanged.

16. A refrigerator unit and/or a freezer unit in accordance with claim 3, wherein the metal jacket (7) comprises a sheet metal section formed chip-free, in particular deep-drawn and/or bent and flanged.

17. A refrigerator unit and/or a freezer unit in accordance with claim 4, wherein the metal jacket (7) comprises a sheet metal section formed chip-free, in particular deep-drawn and/or bent and flanged.

18. A refrigerator unit and/or a freezer unit in accordance with claim 5, wherein the metal jacket (7) comprises a sheet metal section formed chip-free, in particular deep-drawn and/or bent and flanged.

19. A refrigerator unit and/or a freezer unit in accordance with claim 18, wherein the glazing pane holder (12) has a support limb (13) which projects inwardly from the metal frame (5) and on which the flat side of the glazing pane (6) lies, is preferably firmly adhered.

20. A refrigerator unit and/or a freezer unit in accordance with claim 17, wherein the glazing pane holder (12) has a support limb (13) which projects inwardly from the metal frame (5) and on which the flat side of the glazing pane (6) lies, is preferably firmly adhered.
